(19) United States
(12) Patent Application Publication
(10) Pub. No.: US 2020/0209445 A1
(43) Pub. Date: Jul. 2, 2020

(54) MIRROR

(71) Applicant: QISDA CORPORATION, Taoyuan City (TW)

(72) Inventor: Chih-Ming Chang, Taoyuan City (TW)

(21) Appl. No.: 16/411,158

(22) Filed: May 14, 2019

(30) Foreign Application Priority Data
Dec. 28, 2018 (CN) 201811653992.2

(51) Int. Cl. G02B 5/09; F21V 23/00

(52) U.S. Cl. CPC G02B 5/09; B60R 1/12; F21V 23/005

(57) ABSTRACT

A mirror includes a glass substrate, a pattern layer, a circuit board and a light source. The pattern layer is formed on the glass substrate. The pattern layer includes a plurality of polygonal patterns. Each of the polygonal patterns includes a plated region and a non-plated region. One of the plated region and the non-plated region surrounds another one of the plated region and the non-plated region. The circuit board is disposed corresponding to the pattern layer. The light source is disposed on the circuit board. A light emitted by the light source passes through the non-plated region to be projected out of the glass substrate.

### BACKGROUND OF THE INVENTION

### 1. Field of the Invention

The invention relates to a mirror and, more particularly, to a mirror capable of displaying a pattern.

### 2. Description of the Prior Art

A mirror is an object having a smooth surface and capable of reflecting light. At present, various mirrors are considered a necessity by a lot of people in their daily lives. When a consumer purchases a mirror, additional function is also a major consideration in addition to appearance. For further illustration, when two mirrors have identical or similar appearance, the consumer usually purchases the mirror with additional function. Therefore, how to improve additional function of the mirror has become a significant design issue.

### SUMMARY OF THE INVENTION

An objective of the invention is to provide a mirror capable of displaying a pattern, so as to solve the aforesaid problems.

According to an embodiment of the invention, a mirror comprises a glass substrate, a pattern layer, a circuit board and a light source. The pattern layer is formed on the glass substrate. The pattern layer comprises a plurality of polygonal patterns. Each of the polygonal patterns comprises a plated region and a non-plated region. One of the plated region and the non-plated region surrounds another one of the plated region and the non-plated region. The circuit board is disposed corresponding to the pattern layer. The light source is disposed on the circuit board. A light emitted by the light source passes through the non-plated region to be projected out of the glass substrate.

As mentioned in the above, the invention forms the pattern layer comprising a plurality of polygonal patterns on the glass substrate, wherein each of the polygonal patterns comprises a plated region and a non-plated region. Accordingly, when the light emitted by the light source passes through the non-plated region to be projected out of the glass substrate, a pattern corresponding to the polygonal patterns of the pattern layer is formed on the mirror. Since the structural design is simple, the mirror can have an additional function capable of displaying the pattern without increasing much manufacture cost, so as to increase the commercial value of the mirror of the invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a front view illustrating a mirror according to an embodiment of the invention.

FIG. 2 is a partial side view illustrating the mirror shown in FIG. 1.

FIG. 3 is a front view illustrating that the mirror shown in FIG. 1 displays a pattern.

FIG. 4 is a partial side view illustrating the mirror shown in FIG. 3.

FIG. 5 is a partial side view illustrating a mirror according to another embodiment of the invention.

### DETAILED DESCRIPTION

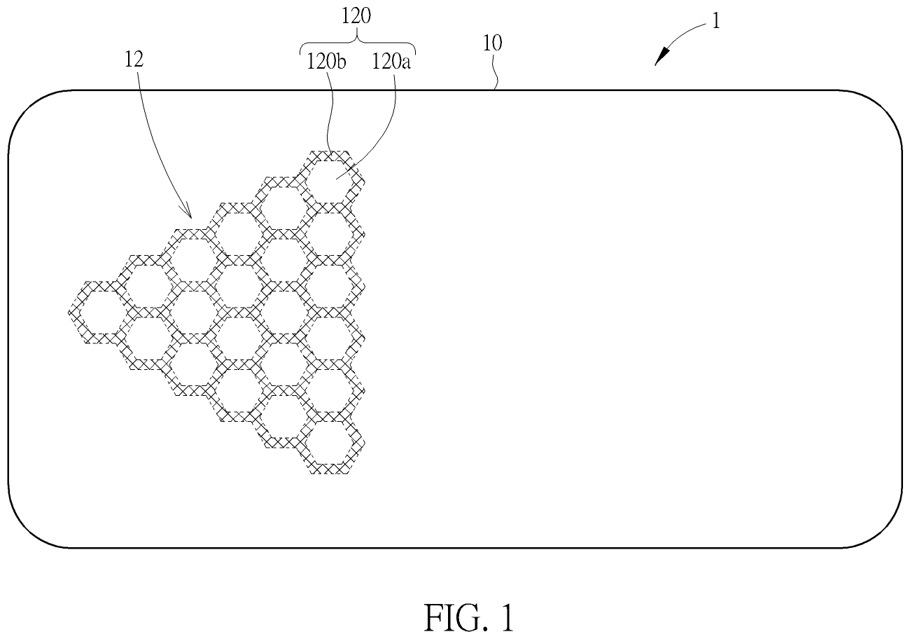

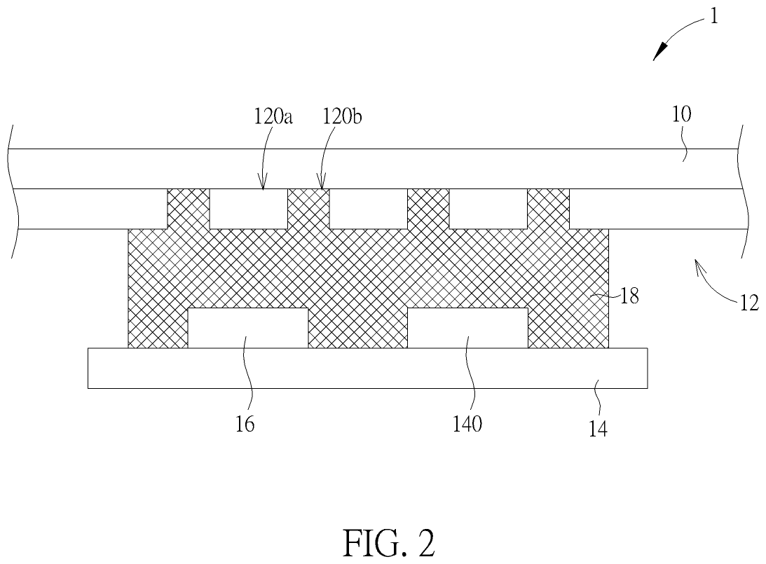

Referring to FIGS. 1 and 2, FIG. 1 is a front view illustrating a mirror 1 according to an embodiment of the invention and FIG. 2 is a partial side view illustrating the mirror 1 shown in FIG. 1.

As shown in FIGS. 1 and 2, the mirror 1 comprises a glass substrate 10, a pattern layer 12, a circuit board 14, a light source 16 and a glue 18. In this embodiment, the mirror 1 may be a side mirror of a vehicle or other transportations. Needless to say, the mirror 1 may also be applied for other purposes (e.g. dress mirror) according to practical applications. The pattern layer 12 is formed on the glass substrate 10, the circuit board 14 is disposed corresponding to the pattern layer 12, and the light source 16 is disposed on the circuit board 14. Furthermore, the circuit board 14 may comprise at least one electronic component 140, wherein the electronic component 140 may be a capacitor, a resistor or other electronic components according to practical applications. In this embodiment, the light source 16 may be, but not limited to, a light emitting diode.

The pattern layer 12 comprises a plurality of polygonal patterns 120 and each of the polygonal patterns 120 comprises a plated region 120a and a non-plated region 120b. In this embodiment, the non-plated region 120b may surround the plated region 120a to form the polygonal pattern. However, in another embodiment, the plated region 120a may also surround the non-plated region 120b to form the polygonal pattern. In other words, one of the plated region 120a and the non-plated region 120b may surround another one of the plated region 120a and the non-plated region 120b to form the polygonal pattern. Furthermore, in this embodiment, each of the polygonal patterns 120 may be, but not limited to, a hexagonal pattern. In practical applications, each of the polygonal patterns 120 may also be a pentagonal pattern, an octagonal pattern or other polygonal patterns.

The invention may plate silver or other metals on the glass substrate 10 first to form the plated region and then etch specific portions of the plated region (corresponding to the non-plated region 102b of each polygonal pattern 120), so as to form the pattern layer 12. Then, the invention may use the glue 18 to adhere the circuit board 14 to the pattern layer 12. At this time, the glue 18 is filled in the non-plated region 120b and the glue 18 covers the light source 16 and the electronic component 140. In this embodiment, the glue 18 maybe a transparent waterproof glue. Accordingly, a light L emitted by the light source 18 can pass through the glue 18 and the non-plated region 120b to be projected out of the glass substrate 10, wherein the glue 18 may scatter the light L uniformly. Furthermore, the glue 18 may provide waterproof function for the light source 16 and the electronic component 140.

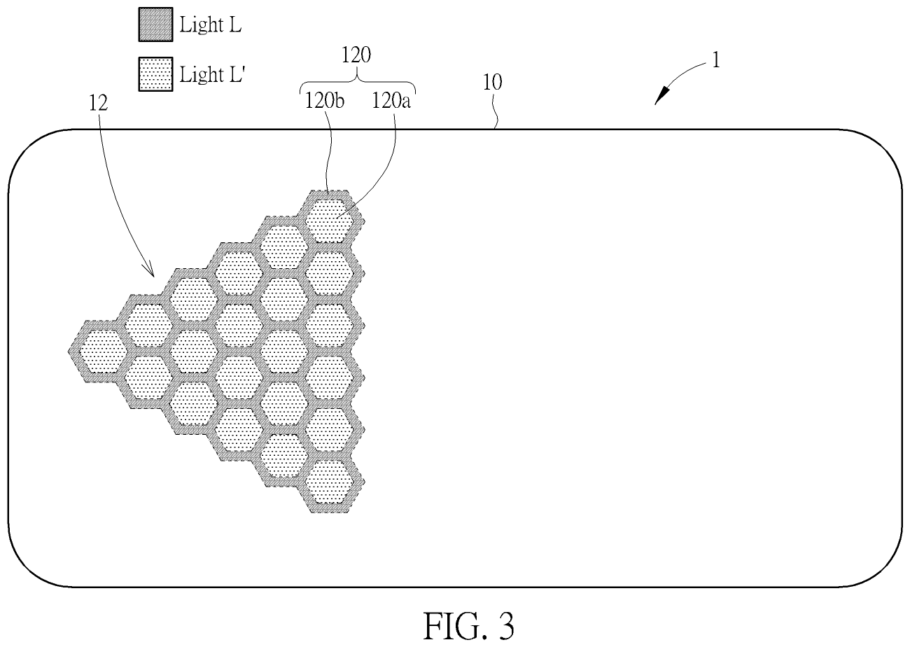

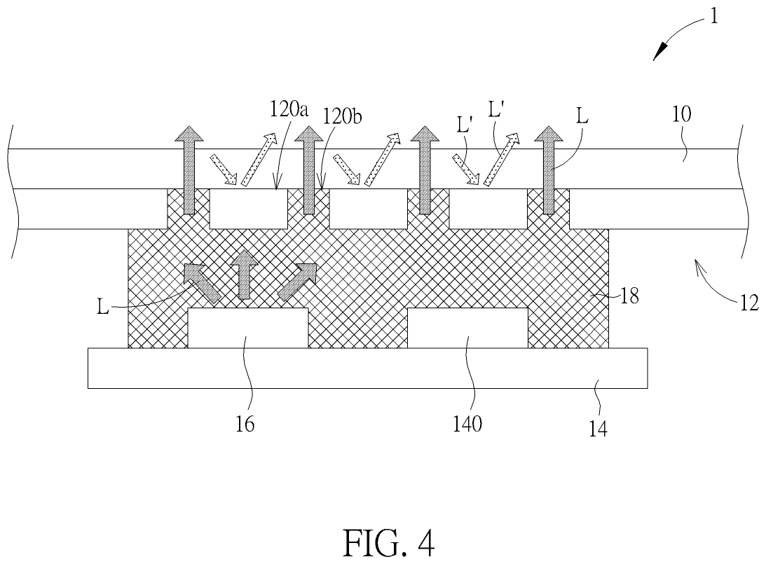

Referring to FIGS. 3 and 4, FIG. 3 is a front view illustrating that the mirror 1 shown in FIG. 1 displays a pattern and FIG. 4 is a partial side view illustrating the mirror 1 shown in FIG. 3.

As shown in FIGS. 3 and 4, when the light source 16 emits the light L, the light L passes through the non-plated region 120b to be projected out of the glass substrate 10, so as to form a pattern corresponding to the polygonal patterns 120 of the pattern layer 12 on the mirror 1. In this embodiment, the polygonal patterns 120 may be adjacent to each other to form a predetermined pattern. For example, when the mirror 1 is a side mirror of a vehicle or other transportations, the predetermined pattern may render an arrow shape for indicating a direction. It should be noted that when the mirror 1 is applied for other purposes (e.g. dress mirror), the predetermined pattern may also render other shapes.

Furthermore, as shown in FIG. 4, when the light L passes through the non-plated region 120b, partial light L′ will be reflected to the plated region 120a in the glass substrate 10 and then reflected by the plated region 120a to be projected out of the glass substrate 10. Accordingly, a user will see the partial light L′ from the plated region 120a of the mirror 1, such that the pattern formed on the mirror 1 will be more complete.

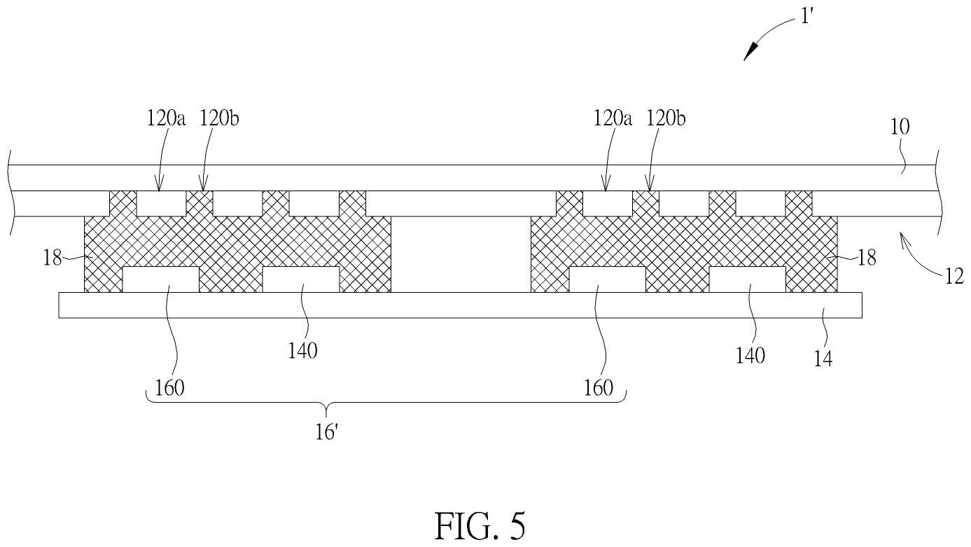

Referring to FIG. 5, FIG. 5 is a partial side view illustrating a mirror 1′ according to another embodiment of the invention. The main difference between the mirror 1′ and the aforesaid mirror 1 is that the light source 16′ of the mirror 1′ comprises a plurality of light emitting units 160, as shown in FIG. 5. In this embodiment, the light emitting unit 160 may be, but not limited to, a light emitting diode. The invention may control at least a part of the light emitting units 160 to emit light to render a predetermined pattern on the glass substrate 10. For example, when the left light emitting unit 160 emits light, a predetermined pattern of leftward arrow may be rendered on the glass substrate 10; and when the right light emitting unit 160 emits light, a predetermined pattern of rightward arrow may be rendered on the glass substrate 10.

As mentioned in the above, the invention forms the pattern layer comprising a plurality of polygonal patterns on the glass substrate, wherein each of the polygonal patterns comprises a plated region and a non-plated region. Accordingly, when the light emitted by the light source passes through the non-plated region to be projected out of the glass substrate, a pattern corresponding to the polygonal patterns of the pattern layer is formed on the mirror. Since the structural design is simple, the mirror can have an additional function capable of displaying the pattern without increasing much manufacture cost, so as to increase the commercial value of the mirror of the invention.

Those skilled in the art will readily observe that numerous modifications and alterations of the device and method may be made while retaining the teachings of the invention. Accordingly, the above disclosure should be construed as limited only by the metes and bounds of the appended claims.

1. A mirror comprising:
a glass substrate;
a pattern layer formed on the glass substrate, the pattern layer comprising a plurality of polygonal patterns, each of the polygonal patterns comprising a plated region and a non-plated region, one of the plated region and the non-plated region surrounding another one of the plated region and the non-plated region;
a circuit board disposed corresponding to the pattern layer; and
a light source disposed on the circuit board, a light emitted by the light source passing through the non-plated region to be projected out of the glass substrate.

2. The mirror of claim 1, wherein the polygonal patterns are adjacent to each other to form a predetermined pattern.

3. The mirror of claim 2, wherein the predetermined pattern renders an arrow shape.

4. The mirror of claim 1, wherein each of the polygonal patterns is a hexagonal pattern.

5. The mirror of claim 1, further comprising a glue, wherein the glue adheres the circuit board to the pattern layer and the glue is filled in the non-plated region.

6. The mirror of claim 5, wherein the circuit board comprises at least one electronic component and the glue covers the light source and the at least one electronic component.

7. The mirror of claim 5, wherein the glue is a transparent waterproof glue.

8. The mirror of claim 1, wherein the light source comprises a plurality of light emitting units and at least a part of the light emitting units is controlled to emit the light to render a predetermined pattern on the glass substrate.
